(19) United States
(12) Patent Application Publication
(10) Pub. No.: US 2018/0101847 A1
(43) Pub. Date: Apr. 12, 2018

(54) USER AND DEVICE AUTHENTICATION FOR WEB APPLICATIONS

(71) Applicant: Microsoft Technology Licensing, LLC, Redmond, WA (US)

(72) Inventor: Matthias Bernard Pisut, IV, Issaquah, WA (US)

(21) Appl. No.: 15/674,963

(22) Filed: Aug. 11, 2017

Related U.S. Application Data
(60) Provisional application No. 62/407,169, filed on Oct. 12, 2016.

(51) Int. Cl. G06Q 20/38; H04L 9/30; G06Q 20/40

(52) U.S. Cl. CPC G06Q 20/3829; G06Q 20/40145; H04L 9/30

(57) ABSTRACT

A computing device, supporting a web browser and one or more biometric sensors for recognizing a device user by capturing biometric characteristics such as the user's face, iris, or fingerprints, is configured to enable web applications to authenticate the user using password-less or two-factor scenarios to enhance online security while reducing password risks such as password guessing, phishing, and keylogging attacks. The present user and device authentication enables online activities having high potential risks, such as online purchases, to be completed securely and conveniently by providing strong cryptographic proof of both the user and a computing device that is trusted by the user.

### STATEMENT OF RELATED APPLICATIONS

This application claims benefit and priority to U.S. Provisional Application Ser. No. 62/407,169 filed Oct. 12, 2016, entitled “User and Device Authentication for Web Applications” which is incorporated herein by reference in its entirety.

### BACKGROUND

Users of computing devices such as smartphones, tablets, wearable-computing devices, and personal computers often need to interact with web applications and other online resources in a manner in which the user is authenticated to enhance security and minimize the opportunities for problems such as impersonation and fraud.

### SUMMARY

A computing device, supporting a web browser and one or more biometric sensors for recognizing a device user by capturing biometric characteristics such as the user's face, iris, or fingerprints, is configured to enable web applications to authenticate the user using password-less or two-factor scenarios to enhance online security while reducing password risks such as password guessing, phishing, and keylogging attacks. The present user and device authentication enables online activities having high potential risks, such as online purchases, to be completed securely and conveniently by providing strong cryptographic proof of both the user and a computing device that is trusted by the user.

In various illustrative examples, the browser exposes an application programming interface (API) that is compliant with portions of the emerging Web Authentication (WebAuthN) standard (formerly referred to as FIDO 2.0 (Fast Identity Online)) which describes an interoperable way of performing online authentication using biometric devices across various browsers. A WebAuthN-compliant device may be configured to function as a trusted payment instrument and emulate traditional chip (i.e., integrated circuit chip or “ICC”) and PIN (personal identification number) functionality that is supported by the EMVCo organization for chip-based payment instruments such as credit and debit cards.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative computing environment in which devices supporting a browser and web applications can communicate and interact with various services over a network;

FIG. 2 shows a local browser and web applications interacting with a remote application service;

FIG. 3 is a diagram of an illustrative end-to-end (E2E) process for handling card-based payments under the current EMV specification referred to here as “chip and PIN”;

FIGS. 4A and 4B show an illustrative process that leverages WebAuthN in e-commerce scenarios to create an analog to the traditional chip and PIN process;

FIGS. 5, 6, and 7 shows illustrative methods;

FIG. 8 shows an illustrative layered architecture;

FIG. 9 is a simplified block diagram of an illustrative computer system such as a personal computer (PC) that may be used in part to implement the present user and device authentication for web applications;

FIG. 10 shows a block diagram of an illustrative device that may be used in part to implement the present user and device authentication for web applications;

FIG. 11 is a block diagram of an illustrative device such as a mobile phone or smartphone; and

FIG. 12 is a block diagram of an illustrative multimedia console.

Like reference numerals indicate like elements in the drawings. Elements are not drawn to scale unless otherwise indicated.

### DETAILED DESCRIPTION

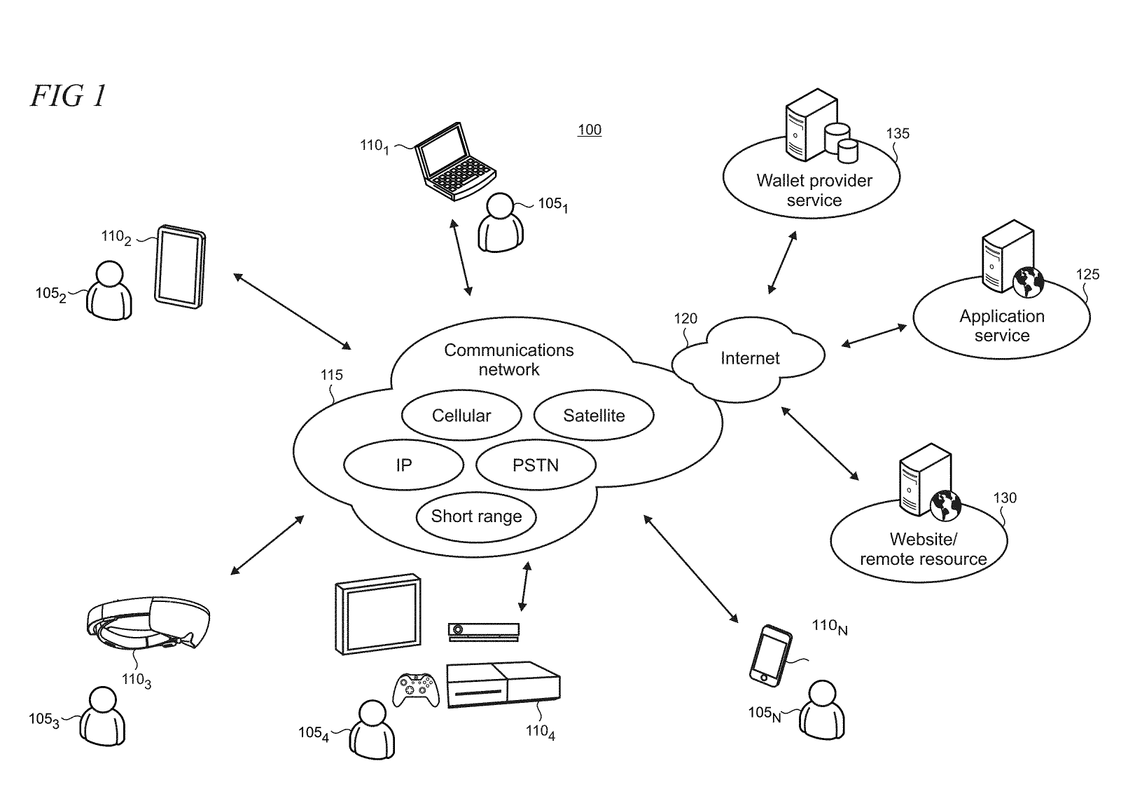

FIG. 1 shows an illustrative computing environment 100 in which the same or different users 105 may employ devices 110 that can communicate with other devices and various services over a network 115. The devices 110 can support voice telephony capabilities in some cases and typically support data-consuming applications such as Internet browsing and multimedia (e.g., music, video, etc.) consumption in addition to various other features. The devices 110 may include, for example, user equipment, mobile phones, cell phones, feature phones, tablet computers, and smartphones which users often employ to make and receive voice and/or multimedia (i.e., video) calls, engage in messaging (e.g., texting) and email communications, use applications and access services that employ data, browse the World Wide Web, and the like.

Other types of electronic devices are also envisioned to be usable within the environment 100 including handheld computing devices, PDAs (personal digital assistants), portable media players, devices that use headsets and earphones (e.g., Bluetooth-compatible devices), phablet devices (i.e., combination smartphone/tablet devices), wearable computing devices such as head-mounted display (HMD) systems and smartwatches, navigation devices such as GPS (Global Positioning System) systems, laptop PCs (personal computers), desktop computers, multimedia consoles, gaming systems, or the like. In the discussion that follows, the use of the term “device” is intended to cover all devices that are configured with communication capabilities and are capable of connectivity to the network 115.

The various devices 110 in the environment 100 can support different features, functionalities, and capabilities (here referred to generally as “features”). Some of the features supported on a given device can be similar to those supported on others, while other features may be unique to a given device. The degree of overlap and/or distinctiveness among features supported on the various devices 110 can vary by implementation. For example, some devices 110 can support touch controls, gesture recognition, and voice commands, while others may enable a more limited user interface. Some devices may support video consumption and Internet browsing, while other devices may support more limited media handling and network interface features.

The devices 110 can typically utilize the network 115 in order to access and/or implement various user experiences. The network can include any of a variety of network types and network infrastructure in various combinations or subcombinations including cellular networks, satellite networks, IP (Internet-Protocol) networks such as Wi-Fi under IEEE 802.11 and Ethernet networks under IEEE 802.3, a public switched telephone network (PSTN), and/or short range networks such as Bluetooth® networks. The network infrastructure can be supported, for example, by mobile operators, enterprises, Internet service providers (ISPs), telephone service providers, data service providers, and the like.

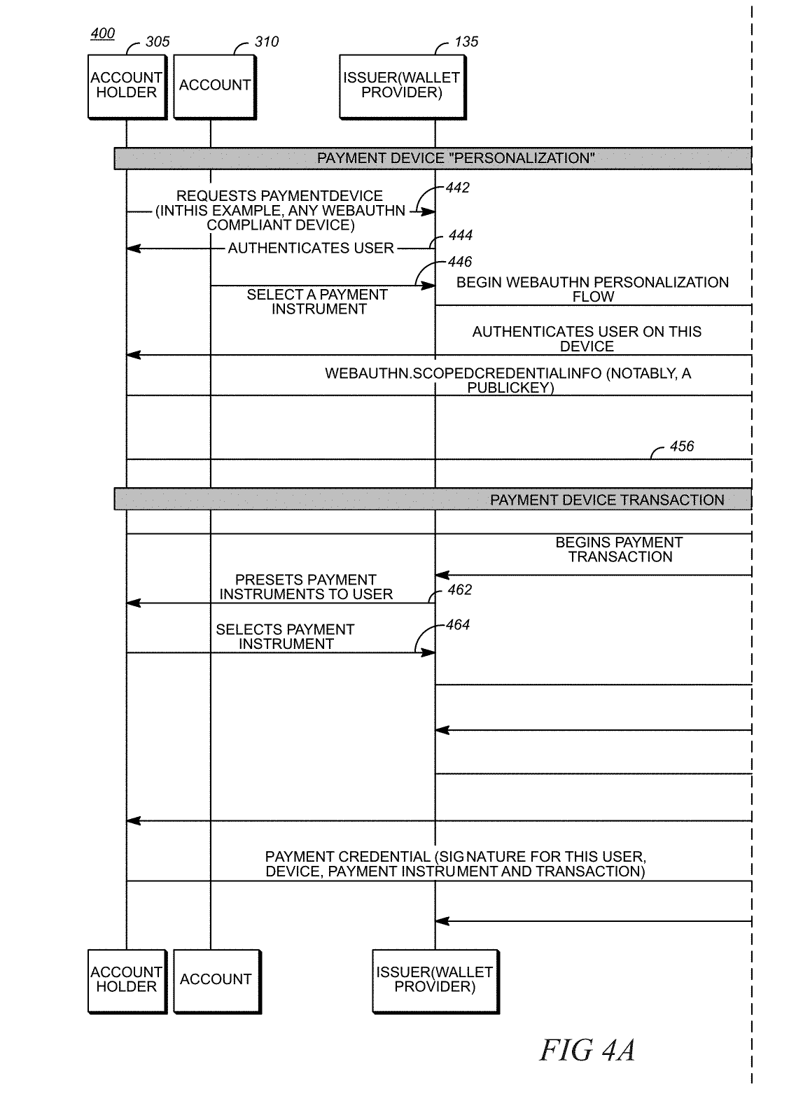

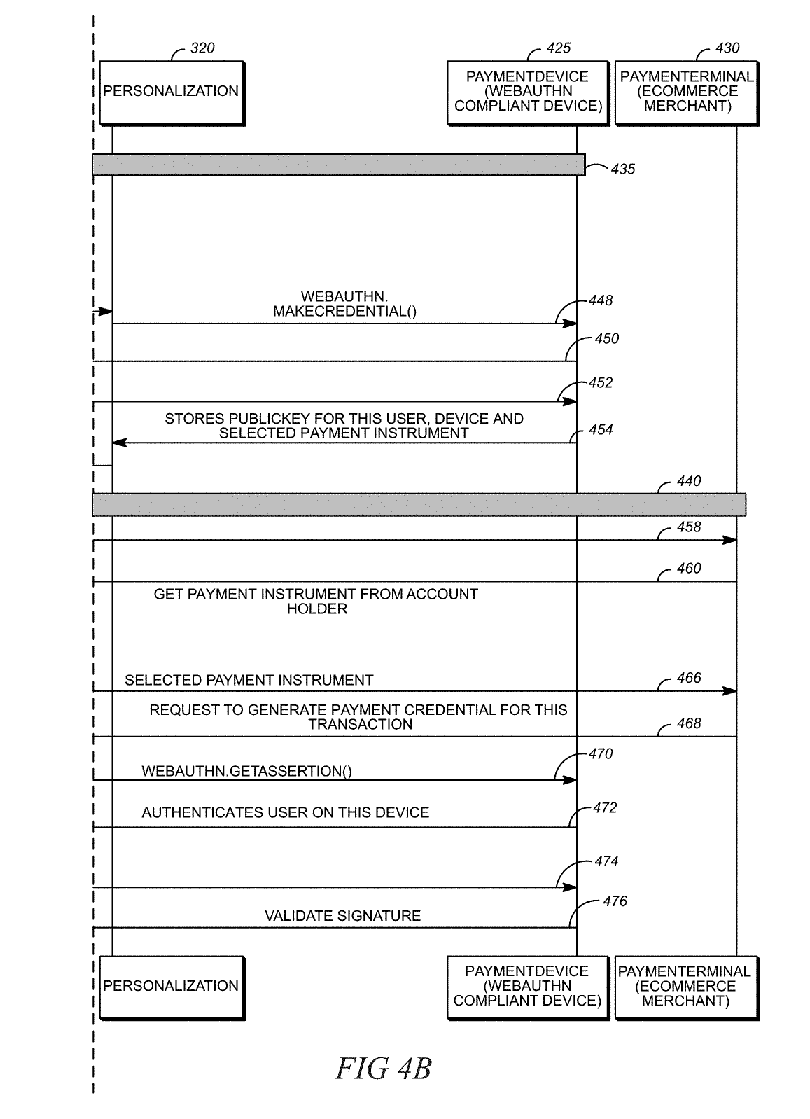

The network 115 may utilize portions of the Internet 120 or include interfaces that support a connection to the Internet so that the devices 110 can access content and render user experiences provided by various remote or cloud-based application services 125 and websites 130. The application services 125 and websites 130 can support a diversity of features, services, and user experiences such as social networking, mapping, news and information, entertainment, travel, productivity, finance, electronic commerce (e-commerce), etc. The application services and websites are collectively referred to as application services in the description that follows. A wallet provider service 135 is also present in the computing environment 100, as shown, and is described in more detail in the text accompanying FIGS. 4A and 4B.

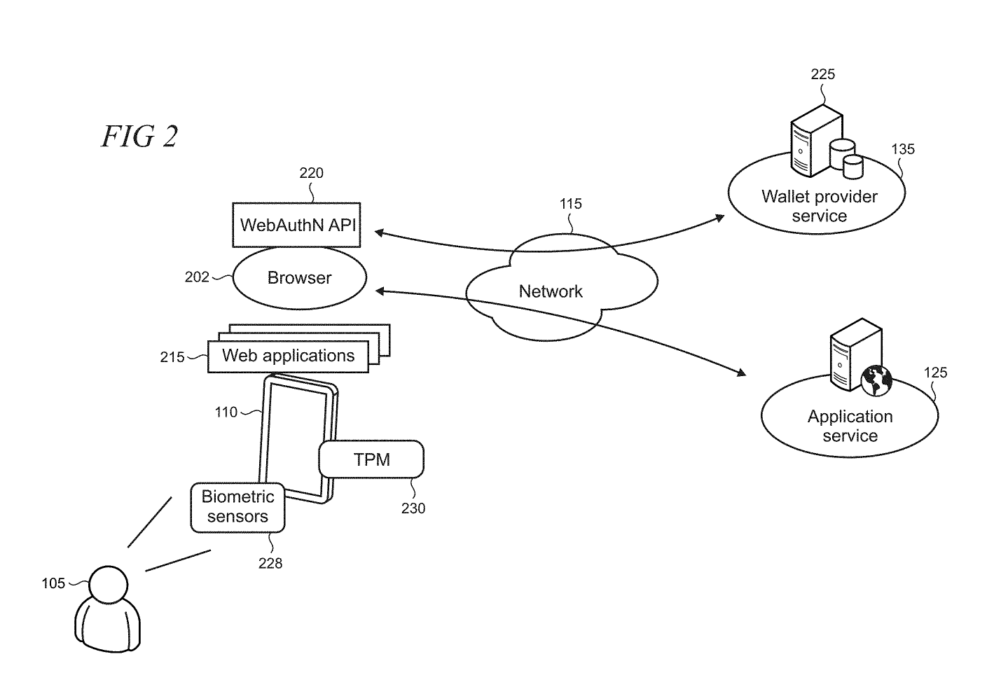

As shown in FIG. 2, a device 110 can include local components such as a browser 202 and/or one or more web applications 215 that can respectively facilitate interaction with one or more application services 125. For example, in some use scenarios, a user 105 may launch a locally executing application that communicates over the network 115 to an application service 125 in order to retrieve data and obtain services to enable various features and functions, provide information, and/or support user experiences that can be supported on various ones of the user interfaces on a local device 110 such as graphical user interfaces (GUIs) and audio user interfaces. The user interfaces for the web applications 215 run in the browser 202.

The browser 202 is configured to comply with various portions of the Web Authentication (WebAuthN) specification (formerly FIDO 2.0) under W3C (World Wide Web Consortium), and may expose a WebAuthN API 220 to register and authenticate users. The WebAuthN API 220 enables applications and services to access strong cryptographic credentials through browser script.

The Web Authentication specification defines two authentication scenarios: password-less and two factor. In the password-less case, the user does not need to log in to use a device using a user name or password—they can log in solely using biometrics such as face, iris, or fingerprint that are recognized by a biometric sensor. In the two factor case, the user logs in normally using a username and password, but biometrics are used as a second factor check to make the overall authentication stronger. By supporting WebAuthN 220, both the browser 202 and device 110 can be viewed as WebAuthN-compliant.

Using WebAuthN, a remote server 225 sends down a plain text challenge to the browser 202. Once the browser is able to verify the user through verification of biometric data from sensors 228, the system will sign the challenge with a private key previously provisioned for the user 105 and send the signature back to the server 225. If the server 225 can validate the signature using the public key it has for that user and verify the challenge is correct, it can authenticate the user securely. With asymmetric cryptography such as this, the public key is meaningless on its own and the private key is never shared. In addition, the private key can be embedded into a trusted platform module (TPM) 230 on the device 110 and thus never be moved from the system. The TPM 230 is a dedicated crypto processor hardware used to store credentials and provide hardware attestation under WebAuthN, as described below. In alternative implementations, authentication credentials comprise credentials such as USB (Universal Serial Bus) keys or Bluetooth devices.

The WebAuthN API 220 provides for user registration using a makeCredential method and authentication for the user with a getAssertion method. The makeCredential method takes the following parameters:

```
user account information --
var userAccountInformation = {
      rpDisplayName: “fido-demo”,
      displayName: email
  };
crypto parameters --
  var cryptoParams = [
      {
          type: “ScopedCred”,
          algorithm: “RSASSA-PKCS1-v1_5”,
      }
  ];
```

The resulting promise returns an object representing the credential that is then sent back to the server for validating future authentications:

```
<script src=“webauthn.js”><!-- polyfill to map Microsoft Edge
experimental implementation to current W3C spec --></script>
<script>
    var email = ‘<%=user.email%>’;
    var name = ‘<%=user.name%>’;
    webauthn.makeCredential(userAccountInformation,
cryptoParams)
        .then(function (creds) {
            document.getElementById(‘form-id’).value =
creds.credential.id;
            document.getElementById(‘form-pk’).value =
JSON.stringify(creds.publicKey);
            document.getElementById(‘form-email’).value =
email;
            document.getElementById(‘form-name’).value =
name;
            document.getElementById(‘theform’).submit( );
        }).catch(function (err) {
            // No acceptable authenticator or user refused
consent. Handle appropriately.
            alert(err);
        });
</script>
```

When makeCredential method is utilized, the browser will first request that face, iris, or fingerprint identification is employed to verify that the user is the same user as the one logged into the device account. Once this step is completed, a public/private key pair is generated and the private key may be stored in the TPM 230. Alternatively, if the TPM is not available, the keys can be stored in software. Under WebAuthN, attestation is employed to attest to the provenance of an authenticator (e.g., the WebAuthN-compliant device) and the data it emits including, for example, credential IDs, public keys, etc. WebAuthN specifically recognizes a TPM attestation format used by WebAuthN-compliant devices that utilize a TPM as their cryptographic engine.

Once the credential is created on the client device, the next time the user attempts to log into the site, the user can sign in using biometrics instead of a password using the getAssertion method. The getAssertion method takes the challenge as its only required parameter. The challenge is the randomly generated quantity that the server will send down to a client to sign with the user's private key. For example:

```
var crypto = require(‘crypto’);
Strategy.prototype.generateChallenge = function( ) {
    return
this.generateVerifiableString(crypto.randomBytes(32));
};
Strategy.prototype.generateVerifiableString = function(data)
{
    // Create cipher using secret
    var d = new Buffer(data);
    var c = crypto.createCipher(‘aes192’,new
Buffer(this._secret));
    // Encrypt data
    c.update(d);
    // Hash results of encrypting data
    var hash = crypto.createHash(‘sha256’);
    hash.update(c.final( ));
    // Combine original data with hash
    return d.toString(‘hex’) + string_separator +
hash.digest(‘hex’);
};
```

Once the getAssertion call is made, the browser will prompt the user to verify her identity using biometrics. After the user is verified, the challenge will be signed within the TPM and the promise will return with an assertion object that contains the signature and other metadata that is sent to the server:

```
<script src=“webauthn.js”><!-- polyfill to map Microsoft Edge
experimental implementation to current W3C spec --></script>
<script>
    var challenge = ‘<%=challenge%>’;
    webauthn.getAssertion(challenge)
    .then(function(assertion) {
      document.getElementById(“form-id”).value =
assertion.credential.id;
      document.getElementById(“form-type”).value =
assertion.credential.type;
      document.getElementById(“form-data”).value =
assertion.clientData;
      document.getElementById(“form-sig”).value =
assertion.signature;
      document.getElementById(“form-authnr”).value =
assertion.authenticatorData;
      document.getElementById(“form-challenge”).value =
challenge;
      document.getElementById(“theform”).submit( );
    })
    .catch(function(err) {
      if(err && err.name) {
        document.getElementById(“form-err”).value = err.name;
      } else {
        document.getElementById(“form-err”).value =
“unknown”;
      }
      document.getElementById(“theform”).submit( );
    });
</script>
```

When the assertion is received at the server, the signature is validated to authenticate the user. For example (in Node.JS):

```
var jwkToPem = require(‘jwk-to-pem’)
var crypto = require(‘crypto’);
var fidoAuthenticator = {
    validateSignature: function (publicKey, clientData,
authnrData, signature, challenge) {
        // Make sure the challenge in the client data
        // matches the expected challenge
        var c = new Buffer(clientData, ‘base64’);
        var cc = JSON.parse(c.toString( ).replace(/\0/g,‘’));
        if(cc.challenge != challenge) return false;
        // Hash data with sha256
        const hash = crypto.createHash(‘sha256’);
        hash.update(c);
        var h = hash.digest( );
        // Verify signature is correct for authnrData + hash
        var verify = crypto.createVerify(‘RSA-SHA256’);
        verify.update(new Buffer(authnrData,‘base64’));
        verify.update(h);
        return
verify.verify(jwkToPem(JSON.parse(publicKey)), signature,
‘base64’);
    }
};
```

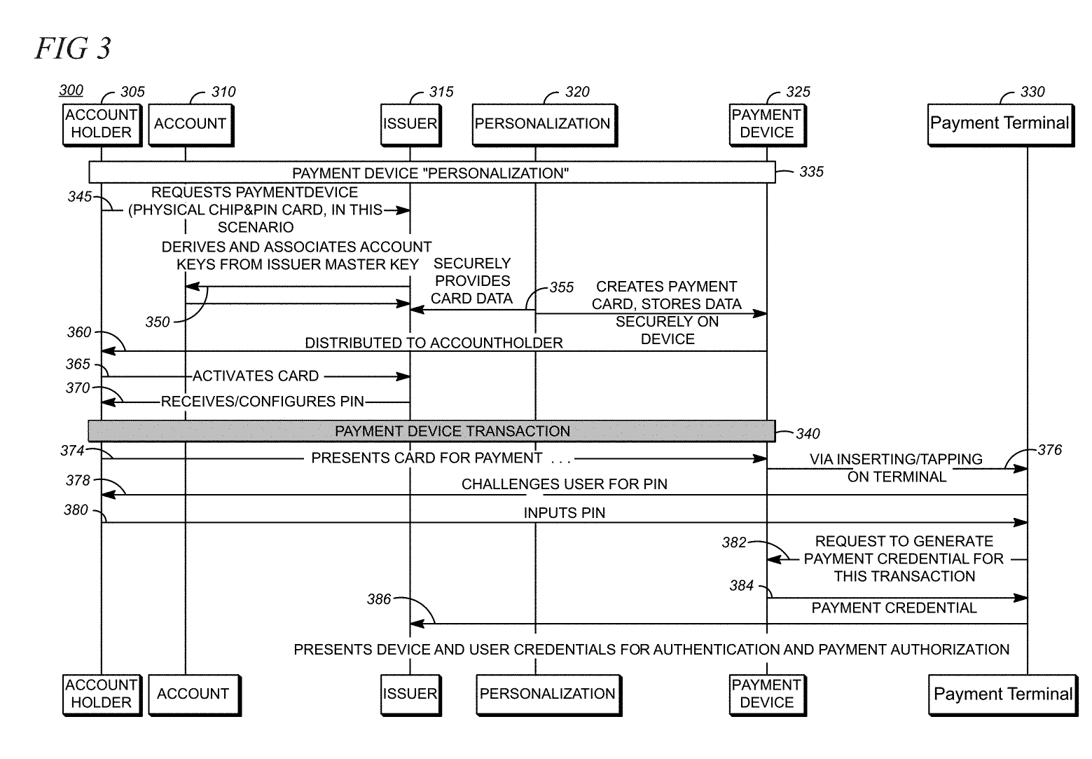

FIG. 3 is a diagram of an illustrative end-to-end (E2E) process 300 for handling card-based payments under the current EMV specification referred to here as “chip and PIN.” EMVCo is an organization that manages the EMV specification covering worldwide interoperability and acceptance of secure payment transactions. EMVCo is overseen by a consortium of six member organizations including American Express, Discover, JCB, MasterCard, UnionPay, and Visa and is supported by dozens of banks, merchants, processors, vendors and other industry stakeholders who participate as EMVCo Associates.

The EMV specification covers standards to prove the presence of an account holder (i.e., the user) on a certified payment device (i.e., card). The basis of this trust includes cryptographically processed messages delivered from cards personalized by banks for a specific account to certified payment terminals connected to payment networks enabled to validate these messages (in the majority of cases, by presenting a payment credential to the issuing bank to authorize). The cards contain an ICC containing a secret issued by the bank and enabled for a particular account. The ICC provides a dynamic payment credential (cryptogram) which indicates presence of the payment device for the specific transaction where it's being requested. Additionally, many cards will not generate this cryptogram without also a strong indicator of presence of the account holder by entry of a PIN on the terminal.

The components shown in FIG. 3 may be defined as follows:

Account Holder 305—the user who holds the account.

Account 310—the bank account where funds are drawn once authorization of an approved user and payment device occurs.

Issuer 315—the issuer of the payment device (e.g., one of the EMVCo consortium members).

Personalization 320—the secured process of binding a payment device to a particular account.

Payment Device 325—the card containing an ICC or “chip” that provides secure crypto storage and a processing unit on the payment device.

PIN—Personal Identification Number used to provide proof of presence of the account holder.

Payment Terminal 330—a device at the point of sale which interfaces with the card to capture card data and proof of presence.

Payment Credential (Cryptogram)—material presented to the payment network and issuing bank to authenticate the payment device and account holder and authorize a specific financial activity such as a payment transaction.

Two illustrative processes are shown in FIG. 3—personalization (indicated by reference numeral 335) and a payment device transaction (indicated by reference numeral 340). In step 345 of the personalization process, the account holder 305 requests a payment device from the issuer 315. The issuer 315 derives account keys from the issuer's master key and associates the key with the account 310 in step 350. In step 355, the issuer 315 securely provides card data for personalization 320, and creates the payment device (i.e., card) 325 which securely stores the data on the ICC. The payment device 325 is distributed to the account holder 305 in step 360. The account holder 305 activates the payment device (e.g., card) with the issuer 315 in step 365, and receives and/or configures a PIN in step 370.

In step 374 of the payment device transaction, the account holder 305 presents the payment device 325 for payment. In step 376, depending on the payment terminal type and configuration, the account holder 305 can either insert the card into a reader in the payment terminal or place the card near the terminal in a tapping or similar motion so that the card data can be read from the ICC using a short range or near field communication technology such as RFID (radio frequency identification). The payment terminal 330 challenges the account holder 305 for the PIN associated with the account in step 378. The account holder 305 inputs the PIN into the payment terminal 330 in step 380. The payment terminal 330 requests generation of a payment credential from the payment device 325 in step 382. In step 384, the payment device 325 provides the payment credential to the payment terminal 330. The payment terminal 330 presents the payment device and user credentials to the issuer 315 for authentication and authorization for the payment in step 386.

FIGS. 4A and 4B show an illustrative process 400 that leverages WebAuthN in e-commerce scenarios to create an analog to the traditional chip and PIN process. In process 400, the card issuer is replaced by the wallet provider service 135 (FIG. 1). The wallet provider service 135 enables WebAuthN devices to be utilized as a digital wallet to provide the convenience of a payment card without having to present the actual card information such as credit/debit card numbers to the e-commerce application. For example, Microsoft Corporation and other entities provide various digital wallet services that can store information relating to multiple payment instruments, for example, from different accounts. The payment device (i.e., card) is replaced by the WebAuthN-compliant device and the payment terminal is replaced by the e-commerce merchant (i.e., e-commerce web application).

As with the EMVCo E2E process shown in FIG. 3, the process 400 in FIGS. 4A and 4B includes an illustrative personalization process 435 and a payment device transaction 440. In step 442 of the personalization process, the account holder 305 requests a payment device (e.g., a WebAuthN-compliant device) from the wallet provider 135 and the account holder is authenticated in step 444. A payment instrument is selected in step 446 and personalization is initiated in step 448 where the makeCredential method (described above) is invoked through the WebAuthN API exposed by the WebAuthN-compliant device 425.

The account holder 305 is authenticated using biometrics in step 450 and credentials including the public key are passed to the WebAuthN-compliant device 425 in step 452. The wallet provider stores the user's public key, WebAuthN-compliant device credential, and the selected payment instrument in step 454. Confirmation of the personalization process may be provided to the account holder 305 in step 456.

In step 458 of the payment device transaction with the e-commerce merchant or e-commerce application 430 (i.e., the substitute for the payment terminal), the account holder 305 begins a payment transaction. The e-commerce application 430 requests the payment instrument from the wallet provider 135 in step 460. The wallet provider 135 presents the various payment instrument options to the account holder in step 462, and the account holder makes the payment instrument selection in step 464. The wallet provider 135 indicates the payment instrument selection to the e-commerce application 430 in step 466.

In step 468, the e-commerce application 430 makes a request to the wallet provider 135 to generate a payment credential for the transaction. The wallet provider 135 invokes the getAssertion method (described above) through the WebAuthN API exposed by the WebAuthN-compliant device 425 in step 470. The WebAuthN-compliant device 425 authenticates the account holder 305 biometrically in step 472. In step 474, the payment credential including user signature, device credential, and payment instrument is provided to the WebAuthN-compliant device 425 which validates the user signature to the wallet provider 135 in step 476. The wallet provider 135 can then complete the transaction with the e-commerce application 430.

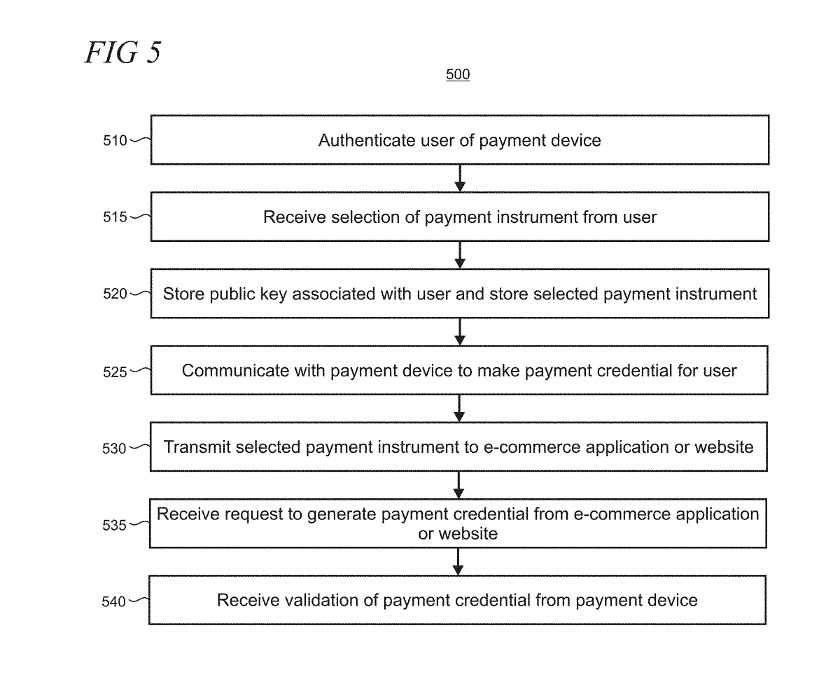

FIG. 5 shows a flowchart of an illustrative method 500 that may be performed by a wallet provider. Unless specifically stated, methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In step 510, the payment device user is authenticated. In step 515, a selection of a payment instrument is received. In step 520, the selected payment instrument is stored along with a public key that is associated with the user. In step 525, communications are implemented with a payment device to make a payment credential for the user. In step 530, the selected payment instrument is transmitted to an e-commerce application or website. In step 535, a request is received from the e-commerce application or website to generate a payment credential. In step 540, validation of the payment credential is received from the payment device.

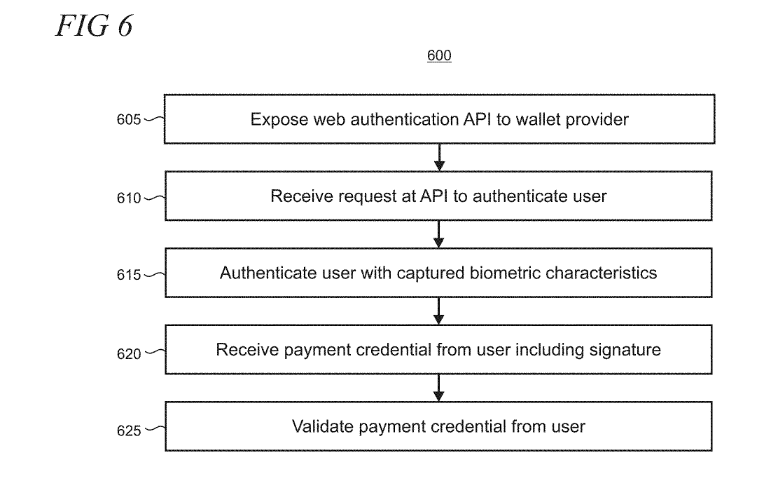

FIG. 6 shows a flowchart of an illustrative method 600 that may be performed by a WebAuthN-compliant device. In step 605, a web authentication API is exposed to a wallet provider. In step 610, a request to authenticate the user is received from the wallet provider. In step 615, the device authenticates the user with captured biometric characteristics. In step 620, a payment credential including a signature is received from the user. In step 625, the device validates the payment credential.

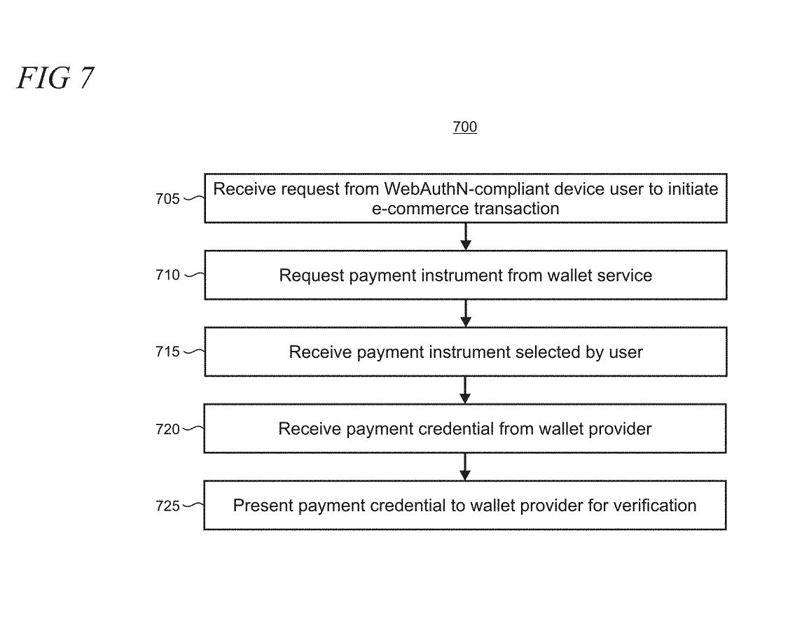

FIG. 7 shows a flowchart of an illustrative method 700 that may be performed by an e-commerce application or website. In step 705, a request to initiate an e-commerce transaction is received from a WebAuthN-compliant device user. In step 710, a payment instrument is requested from a wallet provider. In step 715, a payment instrument selected by the device user is received. In step 720, a payment credential is received from the wallet provider. In step 725, the payment credential is presented back to the wallet provider for verification.

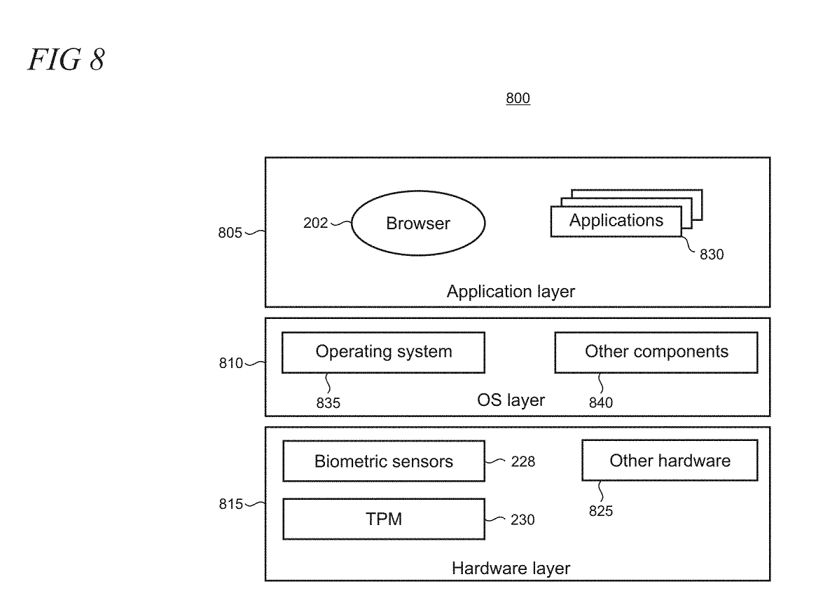

Turning now to various implementation details for the present user and device authentication for web applications, FIG. 8 shows an illustrative layered architecture 800 that may be instantiated on a given device 110. The architecture 800 is typically implemented in software, although combinations of software, firmware, and/or hardware may also be utilized in some cases. The architecture 800 is arranged in layers and includes an application layer 805, an OS (operating system) layer 810, and a hardware layer 815. The hardware layer 815 provides an abstraction of the various hardware used by the device 110 (e.g., input and output devices, networking and radio hardware, etc.) to the layers above it. In this illustrative example, the hardware layer supports one or more biometric sensors 228, the TPM 230, and other hardware 825. The application layer 805 in this illustrative example supports the browser 202 and various applications 830 (productivity, social, entertainment, news and information applications, web applications including e-commerce applications, etc.). The browser 202 exposes the WebAuthN API, as described above, or other suitable components to facilitate interactions with the various components shown in FIGS. 4A and 4B and described in the accompanying text. The OS layer 810 supports an OS 835 and other components 840 as may be needed to implement the various features and functions described herein.

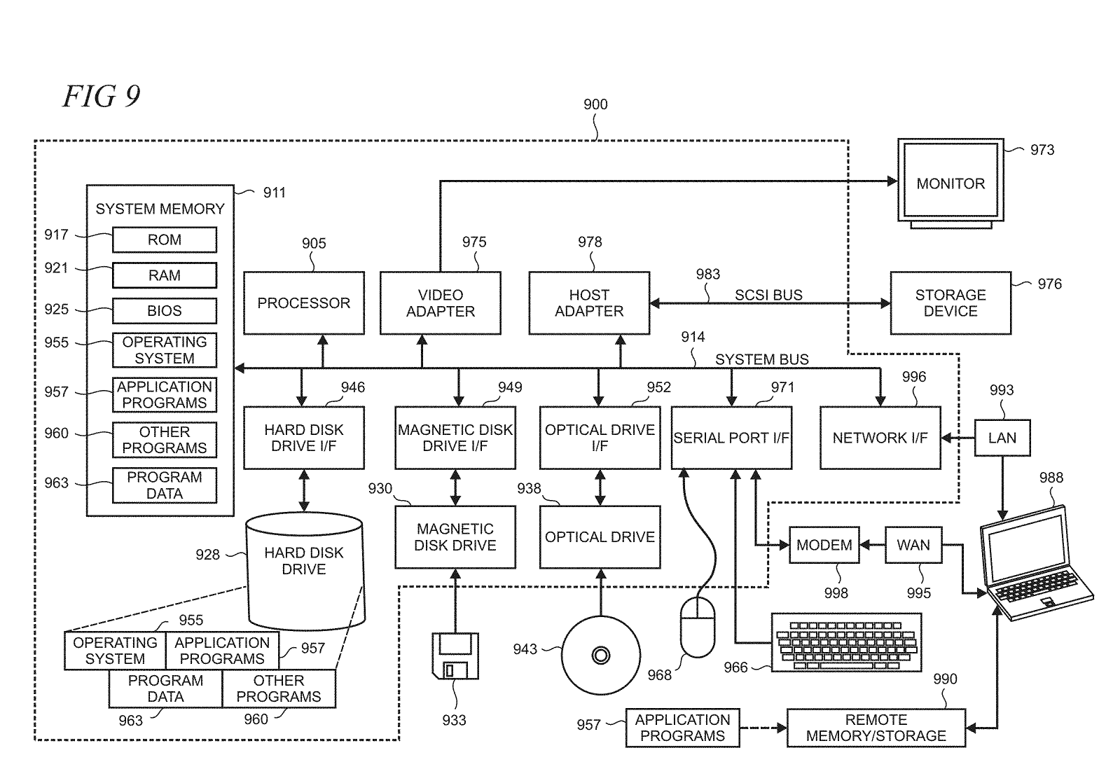

FIG. 9 is a simplified block diagram of an illustrative computer system 900 such as a PC, client machine, or server with which the present user and device authentication for web applications may be implemented. Computer system 900 includes a processor 905, a system memory 911, and a system bus 914 that couples various system components including the system memory 911 to the processor 905. The system bus 914 may be any of several types of bus structures including a memory bus or memory controller, a peripheral bus, or a local bus using any of a variety of bus architectures. The system memory 911 includes read only memory (ROM) 917 and random access memory (RAM) 921. A basic input/output system (BIOS) 925, containing the basic routines that help to transfer information between elements within the computer system 900, such as during startup, is stored in ROM 917. The computer system 900 may further include a hard disk drive 928 for reading from and writing to an internally disposed hard disk (not shown), a magnetic disk drive 930 for reading from or writing to a removable magnetic disk 933 (e.g., a floppy disk), and an optical disk drive 938 for reading from or writing to a removable optical disk 943 such as a CD (compact disc), DVD (digital versatile disc), or other optical media. The hard disk drive 928, magnetic disk drive 930, and optical disk drive 938 are connected to the system bus 914 by a hard disk drive interface 946, a magnetic disk drive interface 949, and an optical drive interface 952, respectively. The drives and their associated computer-readable storage media provide non-volatile storage of computer-readable instructions, data structures, program modules, and other data for the computer system 900. Although this illustrative example includes a hard disk, a removable magnetic disk 933, and a removable optical disk 943, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present user and device authentication for web applications. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 933, optical disk 943, ROM 917, or RAM 921, including an operating system 955, one or more application programs 957, other program modules 960, and program data 963. A user may enter commands and information into the computer system 900 through input devices such as a keyboard 966 and pointing device 968 such as a mouse. Other input devices (not shown) may include a microphone, joystick, game pad, satellite dish, scanner, trackball, touchpad, touchscreen, touch-sensitive device, voice-command module or device, user motion or user gesture capture device, or the like. These and other input devices are often connected to the processor 905 through a serial port interface 971 that is coupled to the system bus 914, but may be connected by other interfaces, such as a parallel port, game port, or universal serial bus (USB). A monitor 973 or other type of display device is also connected to the system bus 914 via an interface, such as a video adapter 975. In addition to the monitor 973, personal computers typically include other peripheral output devices (not shown), such as speakers and printers. The illustrative example shown in FIG. 9 also includes a host adapter 978, a Small Computer System Interface (SCSI) bus 983, and an external storage device 976 connected to the SCSI bus 983.

The computer system 900 is operable in a networked environment using logical connections to one or more remote computers, such as a remote computer 988. The remote computer 988 may be selected as another personal computer, a server, a router, a network PC, a peer device, or other common network node, and typically includes many or all of the elements described above relative to the computer system 900, although only a single representative remote memory/storage device 990 is shown in FIG. 9. The logical connections depicted in FIG. 9 include a local area network (LAN) 993 and a wide area network (WAN) 995. Such networking environments are often deployed, for example, in offices, enterprisewide computer networks, intranets, and the Internet.

When used in a LAN networking environment, the computer system 900 is connected to the local area network 993 through a network interface or adapter 996. When used in a WAN networking environment, the computer system 900 typically includes a broadband modem 998, network gateway, or other means for establishing communications over the wide area network 995, such as the Internet. The broadband modem 998, which may be internal or external, is connected to the system bus 914 via a serial port interface 971. In a networked environment, program modules related to the computer system 900, or portions thereof, may be stored in the remote memory storage device 990. It is noted that the network connections shown in FIG. 9 are illustrative and other means of establishing a communications link between the computers may be used depending on the specific requirements of an application of the present user and device authentication for web applications.

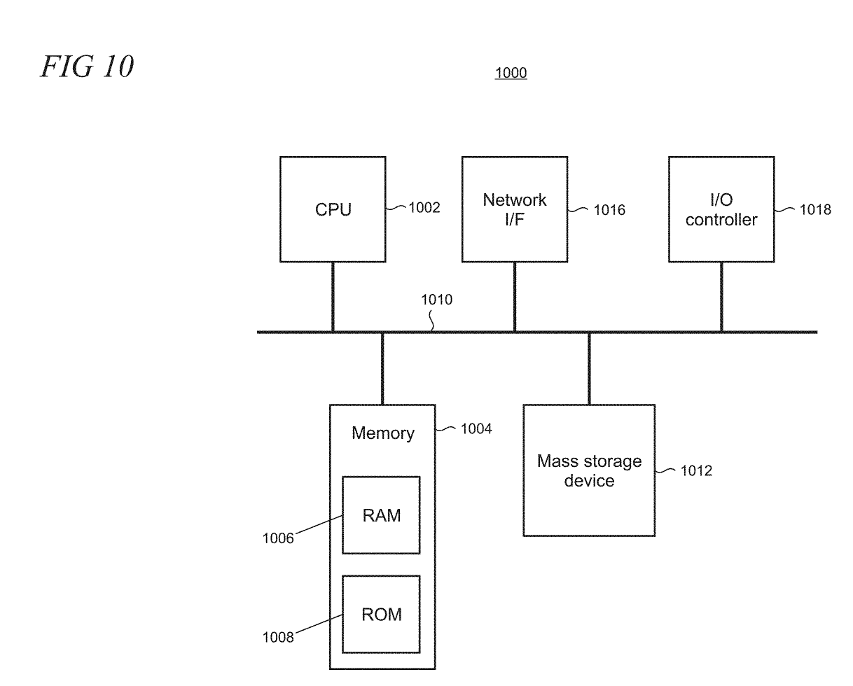

FIG. 10 shows an illustrative architecture 1000 for a device capable of executing the various components described herein for providing the present user and device authentication for web applications. Thus, the architecture 1000 illustrated in FIG. 10 shows an architecture that may be adapted for a server computer, mobile phone, a PDA, a smartphone, a desktop computer, a netbook computer, a tablet computer, GPS device, gaming console, and/or a laptop computer. The architecture 1000 may be utilized to execute any aspect of the components presented herein.

The architecture 1000 illustrated in FIG. 10 includes a CPU (Central Processing Unit) 1002, a system memory 1004, including a RAM 1006 and a ROM 1008, and a system bus 1010 that couples the memory 1004 to the CPU 1002. A basic input/output system containing the basic routines that help to transfer information between elements within the architecture 1000, such as during startup, is stored in the ROM 1008. The architecture 1000 further includes a mass storage device 1012 for storing software code or other computer-executed code that is utilized to implement applications, the file system, and the operating system.

The mass storage device 1012 is connected to the CPU 1002 through a mass storage controller (not shown) connected to the bus 1010. The mass storage device 1012 and its associated computer-readable storage media provide non-volatile storage for the architecture 1000.

Although the description of computer-readable storage media contained herein refers to a mass storage device, such as a hard disk or CD-ROM drive, it may be appreciated by those skilled in the art that computer-readable storage media can be any available storage media that can be accessed by the architecture 1000.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1000.

According to various embodiments, the architecture 1000 may operate in a networked environment using logical connections to remote computers through a network. The architecture 1000 may connect to the network through a network interface unit 1016 connected to the bus 1010. It may be appreciated that the network interface unit 1016 also may be utilized to connect to other types of networks and remote computer systems. The architecture 1000 also may include an input/output controller 1018 for receiving and processing input from a number of other devices, including a keyboard, mouse, or electronic stylus (not shown in FIG. 10). Similarly, the input/output controller 1018 may provide output to a display screen, a printer, or other type of output device (also not shown in FIG. 10).

It may be appreciated that the software components described herein may, when loaded into the CPU 1002 and executed, transform the CPU 1002 and the overall architecture 1000 from a general-purpose computing system into a special-purpose computing system customized to facilitate the functionality presented herein. The CPU 1002 may be constructed from any number of transistors or other discrete circuit elements, which may individually or collectively assume any number of states. More specifically, the CPU 1002 may operate as a finite-state machine, in response to executable instructions contained within the software modules disclosed herein. These computer-executable instructions may transform the CPU 1002 by specifying how the CPU 1002 transitions between states, thereby transforming the transistors or other discrete hardware elements constituting the CPU 1002.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1000 in order to store and execute the software components presented herein. It also may be appreciated that the architecture 1000 may include other types of computing devices, including handheld computers, embedded computer systems, smartphones, PDAs, and other types of computing devices known to those skilled in the art. It is also contemplated that the architecture 1000 may not include all of the components shown in FIG. 10, may include other components that are not explicitly shown in FIG. 10, or may utilize an architecture completely different from that shown in FIG. 10.

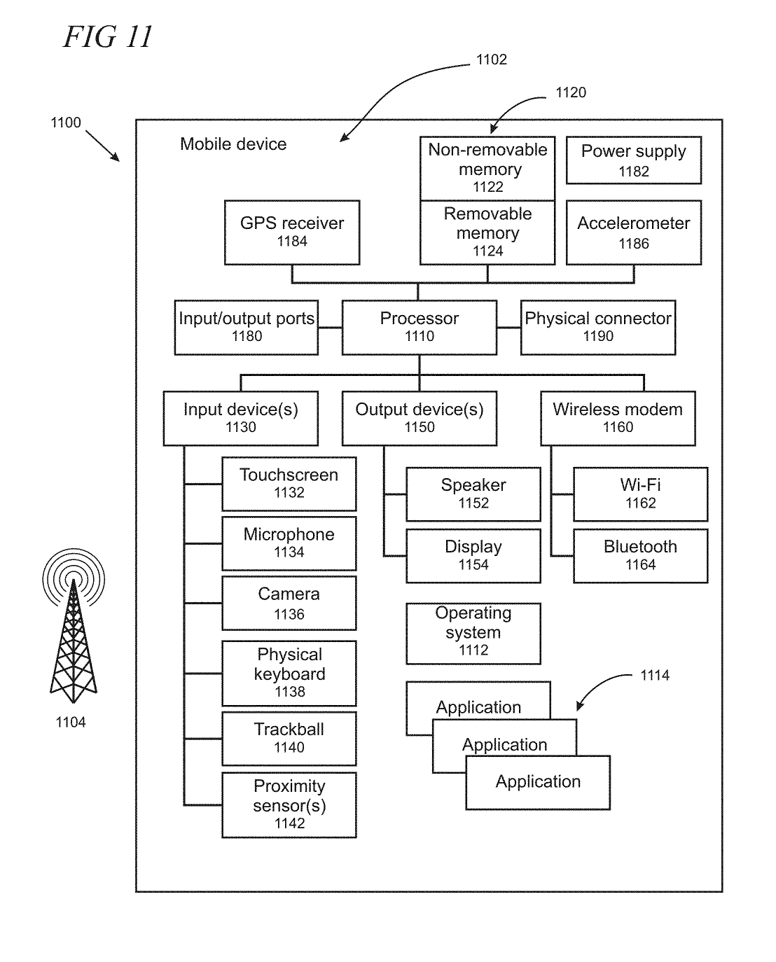

FIG. 11 is a functional block diagram of an illustrative device 1100 such as a mobile phone or smartphone including a variety of optional hardware and software components, shown generally at 1102. Any component 1102 in the mobile device can communicate with any other component, although, for ease of illustration, not all connections are shown. The mobile device can be any of a variety of computing devices (e.g., cell phone, smartphone, handheld computer, PDA, etc.) and can allow wireless two-way communications with one or more mobile communication networks 1104, such as a cellular or satellite network.

The illustrated device 1100 can include a controller or processor 1110 (e.g., signal processor, microprocessor, microcontroller, ASIC (Application Specific Integrated Circuit), or other control and processing logic circuitry) for performing such tasks as signal coding, data processing, input/output processing, power control, and/or other functions. An operating system 1112 can control the allocation and usage of the components 1102, including power states, above-lock states, and below-lock states, and provides support for one or more application programs 1114. The application programs can include common mobile computing applications (e.g., image-capture applications, email applications, calendars, contact managers, web browsers, messaging applications), or any other computing application.

The illustrated device 1100 can include memory 1120. Memory 1120 can include non-removable memory 1122 and/or removable memory 1124. The non-removable memory 1122 can include RAM, ROM, Flash memory, a hard disk, or other well-known memory storage technologies. The removable memory 1124 can include Flash memory or a Subscriber Identity Module (SIM) card, which is well known in GSM (Global System for Mobile communications) systems, or other well-known memory storage technologies, such as “smart cards.” The memory 1120 can be used for storing data and/or code for running the operating system 1112 and the application programs 1114. Example data can include web pages, text, images, sound files, video data, or other data sets to be sent to and/or received from one or more network servers or other devices via one or more wired or wireless networks.

The memory 1120 may also be arranged as, or include, one or more computer-readable storage media implemented in any method or technology for storage of information such as computer-readable instructions, data structures, program modules or other data. For example, computer-readable media includes, but is not limited to, RAM, ROM, EPROM, EEPROM, Flash memory or other solid state memory technology, CD-ROM (compact-disc ROM), DVD, (Digital Versatile Disc) HD-DVD (High Definition DVD), Blu-ray, or other optical storage, magnetic cassettes, magnetic tape, magnetic disk storage or other magnetic storage devices, or any other medium which can be used to store the desired information and which can be accessed by the device 1100.

The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment. The device 1100 can support one or more input devices 1130; such as a touchscreen 1132; microphone 1134 for implementation of voice input for voice recognition, voice commands and the like; camera 1136; physical keyboard 1138; trackball 1140; and/or proximity sensor 1142; and one or more output devices 1150, such as a speaker 1152 and one or more displays 1154. Other input devices (not shown) using gesture recognition may also be utilized in some cases. Other possible output devices (not shown) can include piezoelectric or haptic output devices. Some devices can serve more than one input/output function. For example, touchscreen 1132 and display 1154 can be combined into a single input/output device.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the device and a public switched telephone network (PSTN).

The device can further include at least one input/output port 1180, a power supply 1182, a satellite navigation system receiver 1184, such as a GPS receiver, an accelerometer 1186, a gyroscope (not shown), and/or a physical connector 1190, which can be a USB port, IEEE 1394 (FireWire) port, and/or an RS-232 port. The illustrated components 1102 are not required or all-inclusive, as any components can be deleted and other components can be added.

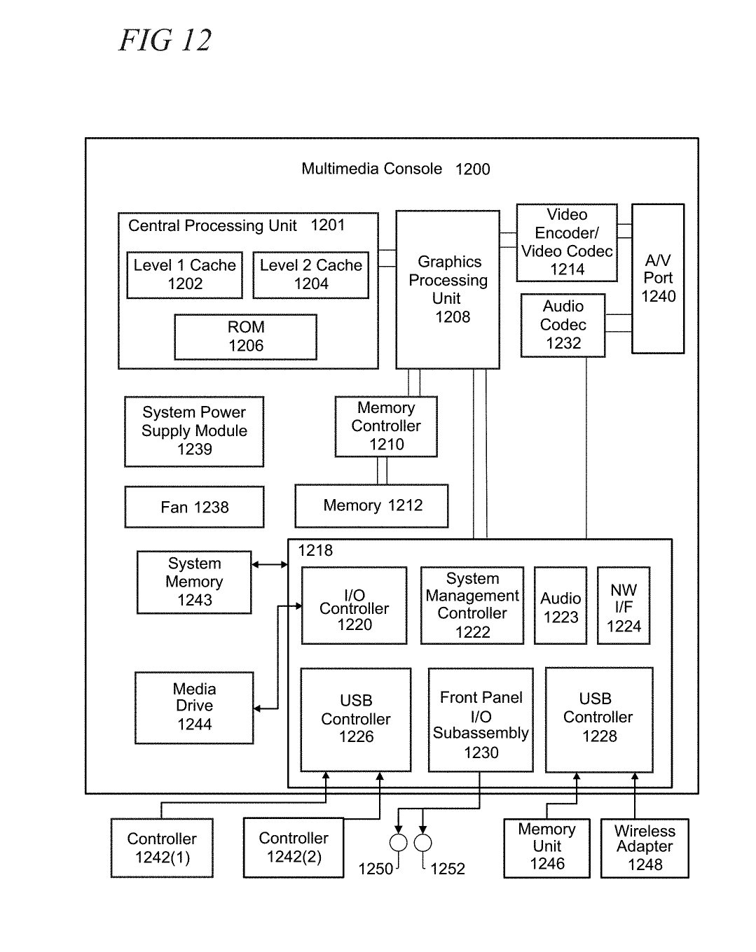

FIG. 12 is an illustrative functional block diagram of a multimedia console 1200. The multimedia console 1200 has a central processing unit (CPU) 1201 having a level 1 cache 1202, a level 2 cache 1204, and a Flash ROM (Read Only Memory) 1206. The level 1 cache 1202 and the level 2 cache 1204 temporarily store data and hence reduce the number of memory access cycles, thereby improving processing speed and throughput. The CPU 1201 may be configured with more than one core, and thus, additional level 1 and level 2 caches 1202 and 1204. The Flash ROM 1206 may store executable code that is loaded during an initial phase of a boot process when the multimedia console 1200 is powered ON.

A graphics processing unit (GPU) 1208 and a video encoder/video codec (coder/decoder) 1214 form a video processing pipeline for high speed and high resolution graphics processing. Data is carried from the GPU 1208 to the video encoder/video codec 1214 via a bus. The video processing pipeline outputs data to an A/V (audio/video) port 1240 for transmission to a television or other display. A memory controller 1210 is connected to the GPU 1208 to facilitate processor access to various types of memory 1212, such as, but not limited to, a RAM.

The multimedia console 1200 includes an I/O controller 1220, a system management controller 1222, an audio processing unit 1223, a network interface controller 1224, a first USB (Universal Serial Bus) host controller 1226, a second USB controller 1228, and a front panel I/O subassembly 1230 that are preferably implemented on a module 1218. The USB controllers 1226 and 1228 serve as hosts for peripheral controllers 1242(1) and 1242(2), a wireless adapter 1248, and an external memory device 1246 (e.g., Flash memory, external CD/DVD ROM drive, removable media, etc.). The network interface controller 1224 and/or wireless adapter 1248 provide access to a network (e.g., the Internet, home network, etc.) and may be any of a wide variety of various wired or wireless adapter components including an Ethernet card, a modem, a Bluetooth module, a cable modem, or the like.

System memory 1243 is provided to store application data that is loaded during the boot process. A media drive 1244 is provided and may comprise a DVD/CD drive, hard drive, or other removable media drive, etc. The media drive 1244 may be internal or external to the multimedia console 1200. Application data may be accessed via the media drive 1244 for execution, playback, etc. by the multimedia console 1200. The media drive 1244 is connected to the I/O controller 1220 via a bus, such as a Serial ATA bus or other high speed connection (e.g., IEEE 1394).

The system management controller 1222 provides a variety of service functions related to assuring availability of the multimedia console 1200. The audio processing unit 1223 and an audio codec 1232 form a corresponding audio processing pipeline with high fidelity and stereo processing. Audio data is carried between the audio processing unit 1223 and the audio codec 1232 via a communication link. The audio processing pipeline outputs data to the A/V port 1240 for reproduction by an external audio player or device having audio capabilities.

The front panel I/O subassembly 1230 supports the functionality of the power button 1250 and the eject button 1252, as well as any LEDs (light emitting diodes) or other indicators exposed on the outer surface of the multimedia console 1200. A system power supply module 1239 provides power to the components of the multimedia console 1200. A fan 1238 cools the circuitry within the multimedia console 1200.

The CPU 1201, GPU 1208, memory controller 1210, and various other components within the multimedia console 1200 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 1200 is powered ON, application data may be loaded from the system memory 1243 into memory 1212 and/or caches 1202 and 1204 and executed on the CPU 1201. The application may present a graphical user interface that provides a consistent user experience when navigating to different media types available on the multimedia console 1200. In operation, applications and/or other media contained within the media drive 1244 may be launched or played from the media drive 1244 to provide additional functionalities to the multimedia console 1200.

The multimedia console 1200 may be operated as a standalone system by simply connecting the system to a television or other display. In this standalone mode, the multimedia console 1200 allows one or more users to interact with the system, watch movies, or listen to music. However, with the integration of broadband connectivity made available through the network interface controller 1224 or the wireless adapter 1248, the multimedia console 1200 may further be operated as a participant in a larger network community.

When the multimedia console 1200 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 1200 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 1201 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 1242(1) and 1242(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

Various exemplary embodiments of the present user and device authentication for web applications are now presented by way of illustration and not as an exhaustive list of all embodiments. An example includes one or more computer-readable memory devices storing instructions which, when executed by one or more processors disposed in a computer server, cause the computer server to: responsively to a request, authenticate a user of a remote payment device; receive a selection of a payment instrument from the user; store a public key associated with the user; store the selected payment instrument; and communicate with the payment device to make a payment credential for the user, wherein the payment device authenticates the user on the payment device using biometrics comprising recognition of at least one of face, iris, or fingerprints, receives credentials from the user including the public key;

In another example, the payment device is a WebAuthN-compliant device. In another example, the WebAuthN-compliant device exposes a WebAuthN application programming interface (API) to the server. In another example, the one or more computer-readable memory devices further include instructions causing the computer server to present payment instruments to the user in response to a user initiation of an e-commerce purchase; receive a selection from the user of a payment instrument for the purchase; transmit the selected payment instrument to an e-commerce application or website; receive a request to generate a payment credential from the e-commerce application or website; and receive validation of the payment credential from the payment device. In another example, the authentication is performed by accessing a WebAuthN application programming interface exposed by the payment device using a getAssertion method. In another example, the payment credential is made by accessing a WebAuthN application programming interface exposed by the payment device using a makeCredential method.

A further example includes a device, comprising: one or more processors; one or more biometric sensors configured to capture biometric characteristics of a device user; a network interface to couple the device to a network to thereby access a remote e-commerce website; and one or more hardware-based memory devices storing computer-readable instructions which, when executed by the one or more processors, cause the device to expose a web authentication application programming interface (API) to a wallet provider, receive a request at the API to authenticate the user, authenticate the user through the biometric characteristics captured by the sensors, receive a payment credential from the user including a signature, and validate the signature.

In another example, the device is compliant with WebAuthN. In another example, the API is a WebAuthN API. In another example, the biometric characteristics include at least one of face, iris, or fingerprint. In another example, the device further comprises a dedicated crypto processor hardware to store the payment credential. In another example, the hardware comprises a trusted platform module (TPM). In another example, the device is embodied in one of personal computer, wearable computer, smartphone, mobile phone, tablet computer, or laptop computer. In another example, biometric sensors are removably detachable from the device and communicate with the device through one of Bluetooth or USB (Universal Serial Bus). In another example, an e-commerce transaction has equivalent effect as that made in accordance with EMVCo specifications. In another example, the biometric sensor comprises one of camera, fingerprint reader, or physiology monitoring device. In another example, the physiology monitoring device is a companion device.

A further example includes a method for authenticating a user for a secure online activity, comprising: receiving a request from a WebAuthN-compliant payment device user to initiate an e-commerce transaction; requesting a payment instrument associated with the user from a wallet provider; receiving a payment instrument selected by the user; and requesting a payment credential from the wallet provider.

In another example, the method is performed by an e-commerce website or application. In another example, the payment device authenticates the user biometrically without using a password.

Various exemplary embodiments of the present user and device authentication for web applications are now presented by way of illustration and not as an exhaustive list of all embodiments. An example includes one or more computer-readable memory devices storing instructions which, when executed by one or more processors disposed in a computer server, cause the computer server to: responsively to a request, authenticate a user of a remote payment device; receive a selection of a payment instrument from the user; store a public key associated with the user; store the selected payment instrument; and communicate with the payment device to make a payment credential for the user, wherein the payment device authenticates the user on the payment device using biometrics comprising recognition of at least one of face, iris, or fingerprints, and receives credentials from the user including the public key.

In another example, the payment device is a WebAuthN-compliant device. In another example, the WebAuthN-compliant device exposes a WebAuthN application programming interface (API) to the server. In another example, the one or more computer-readable memory devices further include instructions causing the computer server to present payment instruments to the user in response to a user initiation of an e-commerce purchase; receive a selection from the user of a payment instrument for the purchase; transmit the selected payment instrument to an e-commerce application or website; receive a request to generate a payment credential from the e-commerce application or website; and receive validation of the payment credential from the payment device. In another example, the authentication is performed by accessing a WebAuthN application programming interface exposed by the payment device using a getAssertion method. In another example, the payment credential is made by accessing a WebAuthN application programming interface exposed by the payment device using a makeCredential method.

A further example includes a device, comprising: one or more processors; one or more biometric sensors configured to capture biometric characteristics of a device user; a network interface to couple the device to a network to thereby access a remote e-commerce website; and one or more hardware-based memory devices storing computer-readable instructions which, when executed by the one or more processors, cause the device to expose a web authentication application programming interface (API) to a wallet provider, receive a request at the API to authenticate the user, authenticate the user through the biometric characteristics captured by the sensors, receive a payment credential from the user including a signature, and validate the signature.

In another example, the device is compliant with WebAuthN. In another example, the API is a WebAuthN API. In another example, the biometric characteristics include at least one of face, iris, or fingerprint. In another example, the device further comprises a dedicated crypto processor hardware to store the payment credential. In another example, the hardware comprises a trusted platform module (TPM). In another example, the device is embodied in one of personal computer, wearable computer, smartphone, mobile phone, tablet computer, or laptop computer. In another example, biometric sensors are removably detachable from the device and communicate with the device through one of Bluetooth or USB (Universal Serial Bus). In another example, an e-commerce transaction has equivalent effect as that made in accordance with EMVCo specifications. In another example, the biometric sensor comprises one of camera, fingerprint reader, or physiology monitoring device. In another example, the physiology monitoring device is a companion device.

A further example includes a method for authenticating a user for a secure online activity, comprising: receiving a request from a WebAuthN-compliant payment device user to initiate an e-commerce transaction; requesting a payment instrument associated with the user from a wallet provider; receiving a payment instrument selected by the user; and requesting a payment credential from the wallet provider.

In another example, the method is performed by an e-commerce website or application and further includes presenting the payment credential back to the wallet provider for verification. In another example, the payment device authenticates the user biometrically without using a password.

Based on the foregoing, it may be appreciated that technologies for user and device authentication for web applications have been disclosed herein. Although the subject matter presented herein has been described in language specific to computer structural features, methodological and transformative acts, specific computing machinery, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and is not be construed as limiting. Various modifications and changes may be made to the subject matter described herein without following the example embodiments and applications illustrated and described, and without departing from the true spirit and scope of the present invention, which is set forth in the following claims.

What is claimed:

1. One or more computer-readable memory devices storing instructions which, when executed by one or more processors disposed in a computer server, cause the computer server to:
responsively to a request, authenticate a user of a remote payment device;
receive a selection of a payment instrument from the user;
store a public key associated with the user;
store the selected payment instrument; and
communicate with the payment device to make a payment credential for the user, wherein the payment device
authenticates the user on the payment device using biometrics comprising recognition of at least one of face, iris, or fingerprints, and
receives credentials from the user including the public key.

2. The one or more computer-readable memory devices of claim 1 in which the payment device is a WebAuthN-compliant device.

3. The one or more computer-readable memory devices of claim 2 in which the WebAuthN-compliant device exposes a WebAuthN application programming interface (API) to the server.

4. The one or more computer-readable memory devices of claim 1 further including instructions causing the computer server to
present payment instruments to the user in response to a user initiation of an e-commerce purchase;
receive a selection from the user of a payment instrument for the purchase;
transmit the selected payment instrument to an e-commerce application or website;
receive a request to generate a payment credential from the e-commerce application or website; and
receive validation of the payment credential from the payment device.

5. The one or more computer-readable memory devices of claim 1 in which the authentication is performed by accessing a WebAuthN application programming interface exposed by the payment device using a getAssertion method.

6. The one or more computer-readable memory devices of claim 1 in which the payment credential is made by accessing a WebAuthN application programming interface exposed by the payment device using a makeCredential method.

7. A device, comprising:
one or more processors;
one or more biometric sensors configured to capture biometric characteristics of a device user;
a network interface to couple the device to a network to thereby access a remote e-commerce website; and
one or more hardware-based memory devices storing computer-readable instructions which, when executed by the one or more processors, cause the device to
expose a web authentication application programming interface (API) to a wallet provider,
receive a request at the API to authenticate the user,
authenticate the user through the biometric characteristics captured by the sensors,
receive a payment credential from the user including a signature, and
validate the signature.

8. The device of claim 7 as compliant with WebAuthN.

9. The device of claim 7 in which the API is a WebAuthN API.

10. The device of claim 7 in which the biometric characteristics include at least one of face, iris, or fingerprint.

11. The device of claim 7 further comprising a dedicated crypto processor hardware to store the payment credential.

12. The device of claim 11 in which the hardware comprises a trusted platform module (TPM).

13. The device of claim 7 as embodied in one of personal computer, wearable computer, smartphone, mobile phone, tablet computer, or laptop computer.

14. The device of claim 7 in which biometric sensors are removably detachable from the device and communicate with the device through one of Bluetooth or USB (Universal Serial Bus).

15. The device of claim 7 in which an e-commerce transaction has equivalent effect as that made in accordance with EMVCo specifications.

16. The device of claim 7 in which the biometric sensor comprises one of camera, fingerprint reader, or physiology monitoring device.

17. The device of claim 16 in which the physiology monitoring device is a companion device.

18. A method for authenticating a user for a secure online activity, comprising:
receiving a request from a WebAuthN-compliant payment device user to initiate an e-commerce transaction;
requesting a payment instrument associated with the user from a wallet provider;
receiving a payment instrument selected by the user; and
requesting a payment credential from the wallet provider.

19. The method of claim 18 in which the method is performed by an e-commerce website or application and further including presenting the payment credential back to the wallet provider for verification.

20. The method of claim 18 in which the payment device authenticates the user biometrically without using a password.
